(19) United States
(12) Patent Application Publication
(10) Pub. No.: US 2024/0396346 A1
(43) Pub. Date: Nov. 28, 2024

(54) CHARGING CONTROL DEVICE AND CHARGING CONTROL METHOD

(71) Applicant: SHANGHAI BANHUI NEW ENERGY TECHNOLOGY CO., LTD., Shanghai (CN)

(72) Inventor: Qianghui HE, Nanjing (CN)

(73) Assignee: SHANGHAI BANHUI NEW ENERGY TECHNOLOGY CO., LTD., Shanghai (CN)

(21) Appl. No.: 18/264,429

(22) PCT Filed: Jan. 25, 2022
(86) PCT No.: PCT/CN2022/073881

§ 371 Date: Aug. 7, 2023

(30) Foreign Application Priority Data
Feb. 5, 2021 (CN) 202110163810.9

(51) Int. Cl. H02J 7/00; H01M 10/44

(52) U.S. Cl. CPC H02J 7/00034; H01M 10/44; H02J 7/007188

(57) ABSTRACT

A charging control device comprises: a charging port, for achieving contact connection of a charging circuit between the device to be charged and the charging control device; a communication port, for achieving contact connection of a communication circuit between the device to be charged and the charging control device; a main control unit, for judging whether contact state of the communication port is normal, so as to generate a communication execution instruction in conditions the communication port is electrically connected; and an execution unit, for receiving the communication execution instruction sent by the main control unit, and conducting the communication circuit between the communication port and the charging station according to the communication execution instruction, so as to enable the charging station start charging in conditions the communication is confirmed to be normal.

### TECHNICAL FIELD

This disclosure belongs to charging control technical field, and relates to a charging method, in particular to a charging control device and a charging control method.

### BACKGROUND

At present, with the improvement of people's living standards and the increasing awareness of energy conservation and environmental protection, the trend of green and low-carbon travel is becoming increasingly apparent. Thus, new energy vehicles are being increasingly accepted by users in the choice of transportation tools. However, there are still many issues need to be solved about the electric vehicles that users select, wherein the limited time to continue driving of electric vehicles, as well as the convenience and safety of charging, have always been several important issues that need to be solved in the promotion process of new energy vehicles. In existing technology, the communication between electric vehicles, as a device to be charged, and the charging device usually uses the non-contact method of communication coils for charging. When the communication coils are not aligned properly, the distance between the communication coils of electric vehicles and the charging device is unreasonable, or the communication coils are faulty, the communication quality can be affected, and even communication interruption or communication error can be caused.

Therefore, how to provide a charging control device and a charging control method to solve the defects of the existing technology that cannot detect the communication status before charging in multiple ways, so as to achieve reliable charging, has become an urgent technical problem for those skilled in the art.

### SUMMARY

Given the drawbacks of the existing technologies mentioned above, the purpose of the disclosure is to provide a charging control device and a charging control method, for solving the problem that the existing technologies cannot detect the communication status before charging in multiple ways to achieve reliable charging.

In order to achieve the above purpose and other related purposes, one embodiment of this disclosure provides a charging control device, wherein two sides of the charging control device are respectively connected to a device to be charged and a charging station, and the charging control device comprises: a charging port, connected to the device to be charged by one end, and connected to a contactor of the charging station by another end, for achieving contact connection of a charging circuit between the device to be charged and the charging control device; a communication port, connected to a device communication port of the device to be charged, for achieving contact connection of a communication circuit between the device to be charged and the charging control device; a main control unit, for judging whether contact state of the communication port is normal, so as to generate a communication execution instruction in conditions the communication port is electrically connected; an execution unit, respectively connected to the main control unit and the communication port, for receiving the communication execution instruction sent by the main control unit, and conducting the communication circuit between the communication port and the charging station according to the communication execution instruction, so as to enable the charging station start charging in conditions the communication is confirmed to be normal; and a power supply unit, connected to the main control unit and the execution unit.

In an embodiment of the disclosure, the communication port is a contact mechanical port, for transmitting signal between the charging control device and the device to be charged in a contact manner.

In an embodiment of the disclosure, the communication port comprises a first charging connection confirmation port and a control confirmation port. The execution unit is used to perform an on/off operation between the first charging connection confirmation port and the charging station, as well as an on/off operation between the control confirmation port and the charging station.

In an embodiment of the disclosure, the communication port comprises a second charging connection confirmation port, a first communication port, a second communication port, an auxiliary power supply positive port and an auxiliary power supply negative port. The execution unit is used to perform an on/off operation between the second charging connection confirmation port, the first communication port, the second communication port, the auxiliary power supply positive port, the auxiliary power supply negative port and the charging station.

In an embodiment of the disclosure, the charging control device further comprises: a detection unit, connected to the main control unit, for generating a detection signal when the device communication port contacts the communication port. The detection signal is used to indicate that electrical conductivity between the communication port and the device communication port is normal.

In an embodiment of the disclosure, the detection unit comprises a travel switch and a proximity switch, wherein the travel switch is used to detect contact state in a X direction, and the proximity switch is used to detect contact state in a Y direction. The main control unit is connected to the travel switch and the proximity switch respectively, for receiving detection signals from the travel switch and the proximity switch.

In an embodiment of the disclosure, the detection unit comprises a first detection switch, a second detection switch and a third detection switch, wherein the first detection switch is used to detect contact state in a X direction, the second detection switch is used to detect contact state in a Y direction, and the third detection switch is used to detect contact state in a Z direction. The main control unit is connected to the first detection switch, the second detection switch and the third detection switch respectively, for receiving detection signals from the first detection switch, the second detection switch and the third detection switch.

In an embodiment of the disclosure, the power supply unit comprises a first power supply unit and a second power supply unit. The first power supply unit is connected to the detection unit, and supplies power to the detection unit. The second power supply unit is connected to the main control unit and the execution unit, and supplies power to the main control unit and the execution unit.

To achieve the above and other related purposes, another embodiment of the disclosure provides a charging control method, wherein the charging control method comprises: detecting contact state of a communication port; judging whether the contact state of the communication port is normal, so as to generate a communication execution instruction in conditions the communication port is electrically conductive; conducting the communication circuit between the communication port and charging station according to the communication execution instruction, so as to enable the charging station start charging in conditions the communication is confirmed to be normal.

In an embodiment of the disclosure, the step of detecting contact state of a communication port is performed by a detection unit. The detection unit comprises a first detection switch, a second detection switch and a third detection switch, wherein the first detection switch is used to detect the contact state in a X direction, the second detection switch is used to detect the contact state in a Y direction, and the third detection switch is used to detect the contact state in a Z direction. The step of the judging whether the contact state of the communication port is normal, so as to generate a communication execution instruction in conditions the communication port is electrically conductive comprises: generating the communication execution instruction when simultaneously obtaining detection signals of the first detection switch, the second detection switch and the third detection switch.

As mentioned above, the charging control device and the charging control method described in the disclosure have the following beneficial effects:

The disclosure detects the contact state of the communication port through the main control unit, and the control execution unit conducts the communication circuit between the communication port and the charging station when the contact state is electrically connected, thereby realizing the detection of the communication state, so as to start charging when the communication state is normal. Therefore, double insurance of contact state and communication state detection in the communication circuit detection of the charging control process is realized, which can maximize the reliability and safety of charging. Further, the communication port of the disclosure is connected to a device communication port of the device to be charged through a contact mechanical port, which has higher communication reliability compared to the non-contact communication of existing communication coil.

### BRIEF DESCRIPTION OF THE DRAWINGS

FIG. 1 shows the structural schematic diagram of the charging control device in an embodiment of the disclosure.

FIG. 2 shows the detection principle diagram of the charging control device in an embodiment of the disclosure.

FIG. 3 shows the AC charging control principle diagram of the charging control device in an embodiment of the disclosure.

FIG. 4 shows the DC charging control principle diagram of the charging control device in an embodiment of the disclosure.

FIG. 5 shows the schematic flowchart of the charging control method in an embodiment of the disclosure.

### COMPONENTS SIGNS DESCRIPTION

1 charging control device
11 charging port
12 communication port
13 main control unit
14 execution unit
15 power supply unit
16 detection unit
2 device to be charged
3 charging station
S51˜S53 steps

### DETAILED DESCRIPTION OF EMBODIMENTS

The embodiment of the disclosure is illustrated below by specific examples, and those skilled in the art can easily understand other advantages and functions of the disclosure by the content disclosed in the present specification. The disclosure can also be implemented or applied through different specific embodiments, and the details in this specification can also be modified or changed based on different perspectives and applications without departing from the spirit of the disclosure. It should be noted that, without conflicts, the following embodiments and the features in the embodiments can be combined with each other.

It should be noted that the illustrations provided in the following embodiments only illustrate the basic concept of the disclosure in a schematic manner. Therefore, the illustrations only show the components related to the disclosure and are not drawn based on the actual number, shape and size of the components during implementation. The type, quantity and proportion of each component during actual implementation can be arbitrarily changed, and the component layout may also be more complex.

The charging control device and the charging control method described in the disclosure achieve double insurance in the communication circuit detection of the charging control process, which can maximize the reliability and safety of charging.

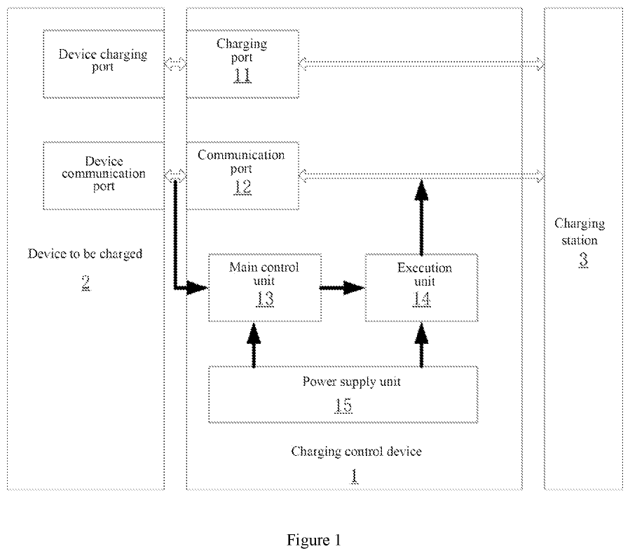

The following will elaborate on the principle and implementation method of a charging control device and a charging control method of this embodiment in combination with FIGS. 1 to 5, so that those skilled in the art can understand the charging control device and charging control method of this embodiment without creative effort.

The following will provide a detailed description of the charging control device provided in this embodiment in conjunction with the diagram. It should be noted that the division of the various units of the charging control device is only a logical functional division, which can be fully or partially integrated into a physical entity or physically separated during actual implementation. And these units can all be implemented in the form of software calling through processing components, or all be implemented in the form of hardware, or partially be implemented in the form of software calling through processing components and partially be implemented in the form of hardware. For example, a unit can be a separate processing element or implemented by integrating into a chip of the charging control device described below. In addition, a unit can also be stored in a memory of the charging control device in the form of program code, called by a processing element of the charging control device described below, and execute the function of a unit described below. The implementation of other units is similar. All or part of these units can be integrated together or implemented independently. The processing element described here can be an integrated circuit with signal processing capabilities. In the implementation process, the following units can be completed by the integrated logic circuit of hardware or instructions in the form of software in the processor element.

Please refer to FIG. 1, which shows the structural schematic diagram of the charging control device in an embodiment of the disclosure. As shown in FIG. 1, two sides of the charging control device 1 described in the disclosure are respectively connected to a device to be charged 2 and a charging station 3. The charging control device 1 comprises: a charging port 11, a communication port 12, a main control unit 13, an execution unit 14 and a power supply unit 15.

One end of the charging port 11 is connected to the device charging port of the device to be charged 2, and the other end is connected to a contactor of the charging station 3, for realizing the contact connection of the charging circuit between the device to be charged 2 and the charging control device 1.

The communication port 12 is connected to a device communication port of the device to be charged 2, for achieving contact connection between the device to be charged 2 and the charging control device 1.

The main control unit 13 is used to judge whether the contact state of the communication port 12 is normal, so as to generate a communication execution instruction when the communication port 12 is electrically connected.

The execution unit 14 is respectively connected to the main control unit 13 and the communication port 12, for receiving the communication execution instruction sent by the main control unit 13, and conducting the communication circuit between the communication port 12 and the charging station 3 according to the communication execution instruction, so as to enable the charging station 3 start charging in conditions the communication is confirmed to be normal.

The power supply unit 15 is connected to the main control unit 13 and the execution unit 14.

In an embodiment, the communication port is a contact mechanical port, for transmitting signal between the charging control device and the device to be charged in a contact manner. Preferably, the contact mechanical port can be a copper bar. Therefore, the communication port of the device to be charged can also use a copper bar to achieve communication through the contact between the copper bars of the device to be charged and the charging control device.

Further, the copper bar adopts the same model as the charging port and device charging port, so that while the charging copper bar is aligned and in normal contact, the copper bar used for communication is also aligned and in normal contact.

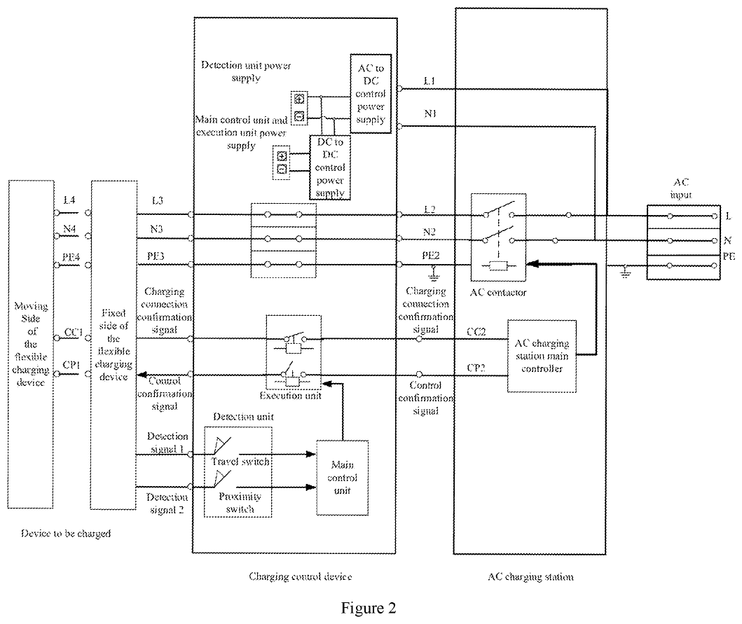

Please refer to FIG. 2, which shows the detection principle diagram of the charging control device in an embodiment of the disclosure. As shown in FIG. 2, the charging control device further comprises a detection unit 16.

The detection unit 16 is connected to the main control unit 13, for generating a detection signal when the device communication port contacts the communication port 12. The detection signal is used to indicate that the electrical conductivity between the communication port and the device communication port is normal.

In an embodiment, the power supply unit comprises a first power supply unit and a second power supply unit.

The first power supply unit is connected to the detection unit, and supplies power to the detection unit.

The second power supply unit is connected to the main control unit and the execution unit, and supplies power to the main control unit and the execution unit.

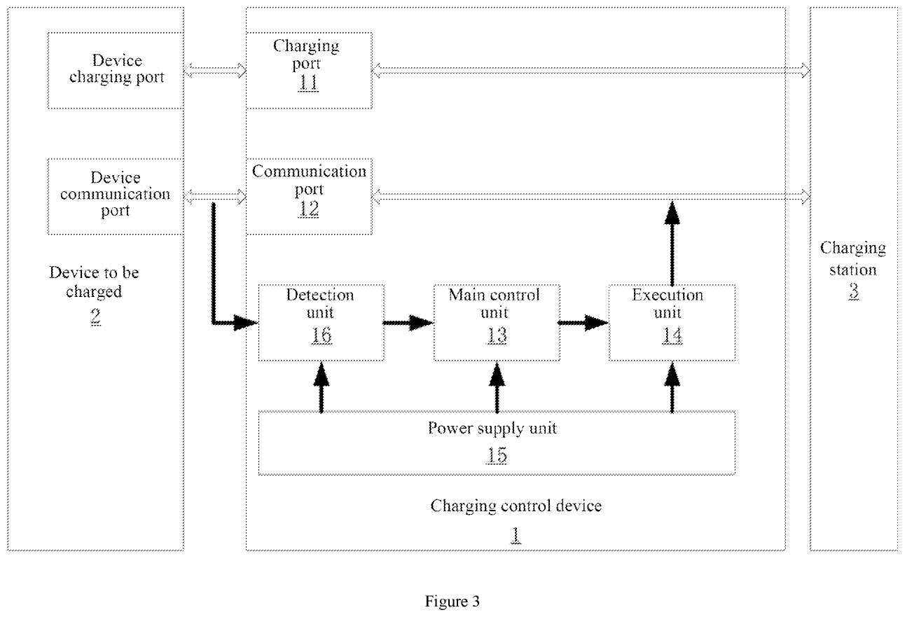

Please refer to FIG. 3, which shows the AC charging control principle diagram of the charging control device in an embodiment of the disclosure. As shown in FIG. 3, a fixed side of a flexible charging device is fixed with charging ports (L3 port, N3 port and PE3 port) and communication ports (first charging connection confirmation port and control confirmation port) of the charging control device. A moving side of a flexible charging device of a device to be charged approaches and contacts the fixed side of the flexible charging device, thereby aligning with the charging port and the communication port of the charging control device, and achieving normal contact.

In an embodiment, the communication port comprises a first charging connection confirmation port and a control confirmation port.

The execution unit is used to perform the on/off operation between the first charging connection confirmation port and the charging station, as well as the on/off operation between the control confirmation port and the charging station.

In an embodiment, the detection unit comprises a travel switch and a proximity switch.

Specifically, the travel switch is used to detect contact state in a X direction, and the proximity switch is used to detect contact state in a Y direction.

The main control unit is respectively connected to the travel switch and the proximity switch, for receiving detection signals of the travel switch and the proximity switch, that is, detection signal 1 and detection signal 2.

As shown in FIG. 3, the implementation principle of the charging control device described in the disclosure in AC charging is specifically as follows: when the device to be charged contacts the charging control device, the device charging port (L4 port, N4 port and PE4 port) contacts and aligns with the charging port (L3 port, N3 port and PE3 port), and the first charging connection confirmation port contacts and aligns with the control confirmation port, thereby knowing that the device to be charged is close to the charging control device, and a preset charging distance has been reached to meet a charging requirement. Therefore, in the X direction, when the device to be charged contacts the travel switch, the travel switch generates a detection signal 1 and transmits the detection signal 1 to the main control unit. In the Y direction, when the device to be charged is sensed by the proximity switch, the proximity switch generates a detection signal 2 and transmits the detection signal 2 to the main control unit. When simultaneously detects both detection signal 1 and detection signal 2, the main control unit sends a communication execution instruction to the execution unit. The execution unit performs a closing operation based on the communication execution instruction. Thus, the charging connection confirmation signal and the control confirmation signal are transmitted from the fixed side of the flexible charging device to the side of the charging station. The communication circuit between the charging station and the device to be charged is connected, and judging whether the communication state is normal according to the charging connection confirmation signal and the control confirmation signal. When the communication is normal, the AC contactor in the charging station is closed, so that L2, N2, PE2 are correspondingly connected with L, N, PE, and L3, N3, PE3 are correspondingly connected with L2, N2 PE2. The AC contactor connects the charging circuit between the device to be charged and the charging station as a charging switch to start charging.

Further, the execution unit is a relay containing two switches. The execution unit executes the closing operation of the relay according to the communication execution instruction. Thus, the charging connection confirmation signal and the control confirmation signal are transmitted from the fixed side of the flexible charging device to the side of the charging station, and the communication circuit between the charging station and the device to be charged is connected.

Further, the L1 and N1 power lines in the AC charging station are led out from the AC input (L, N) to supply power to the detection unit through the first power supply unit (i.e. AC to DC control power supply), leading out the output voltage of the first power supply unit, and supply power to the main control unit and the execution unit through the second power supply unit (i.e. DC to DC control power supply).

It should be noted that both the travel switch and the proximity switch can achieve the function of detecting the contact state of the communication port. The travel switch is also known as a limit switch. When the device to be charged approaches and contacts the travel switch, the connecting rod of the travel switch drives the contact of the switch to open a closed contact, or close an open contact. The proximity switch is also known as contactless travel switch, which can achieve travel control and limit protection functions. In the disclosure, the travel switch and the proximity switch can be interchanged. For the proximity switch, in practical applications, the installation position of the proximity switch can be embedded on the fixed side of the flexible charging device within an appropriate distance range, to ensure stable contact between the charging port and the communication port when the sensing position of the device to be charged is close to the proximity switch.

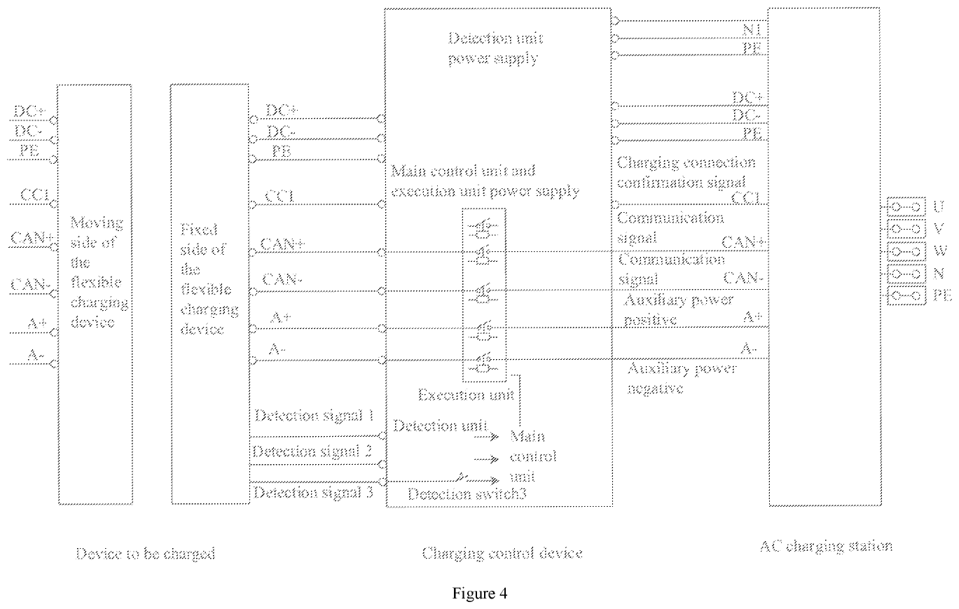

Please refer to FIG. 4, which shows the DC charging control principle diagram of the charging control device in an embodiment of the disclosure. As shown in FIG. 4, the fixed side of the flexible charging device is fixed with charging ports (D+ port, D− port and PE port) and communication ports (CC1 port, CAN+ port, CAN− port, A+ port and A− port). The moving side of the flexible charging device is set on the device to be charged. The moving side of the flexible charging device is equipped with ports corresponding to the fixed side of the flexible charging device, that is, device charging port (D+ port, D− port and PE port) and device communication port (CC1 port, CAN+ port, CAN− port, A+ port and A− port). When approaching and contacting the fixed side of the flexible charging device, the moving side of the flexible charging device of the device to be charged aligns with the charging port and the communication port of the charging control device to achieve normal contact.

In an embodiment, the communication port comprises a second charging connection confirmation port (CC1 port), a first communication port (CAN+ port), a second communication port (CAN− port), an auxiliary power positive port (A+ port), and an auxiliary power negative port (A− port).

The execution unit is used to perform the on/off operation between the second charging connection confirmation port (CC1 port), the first communication port (CAN+ port), the second communication port (CAN− port), the auxiliary power positive port (A+ port), the auxiliary power negative port (A− port) and the charging station.

In an embodiment, the detection unit comprises a first detection switch (detection switch 1), a second detection switch (detection switch 2) and a third detection switch (detection switch 3). The first detection switch (detection switch 1) is used to detect the contact state in the X direction. The second detection switch (detection switch 2) is used to detect the contact state in the Y direction. The third detection switch (detection switch 3) is used to detect the contact states in the Z direction.

The main control unit is respectively connected to the first detection switch (detection switch 1), the second detection switch (detection switch 2), and the third detection switch (detection switch 3), for receiving detection signals from the first detection switch (detection switch 1), the second detection switch (detection switch 2), and the third detection switch (detection switch 3).

As shown in FIG. 4, the implementation principle of the charging control device described in the disclosure in DC charging is specifically as follows: when the device to be charged contacts the charging control device, the charging ports (DC+ port, DC− port and PE port) are contacted and aligned, the second charging connection confirmation port (CC1 port), the first communication port (CAN+ port), the second communication port (CAN− port), the auxiliary power supply positive port (A+ port) and the auxiliary power supply negative port (A− port) are contacted and aligned, so as to know that the device to be charged is close to the charging control device, and a preset charging distance has been reached to meet a charging requirement. Therefore, in the X direction, the device to be charged contacts the detection switch 1 to generate a detection signal 1, and transmits the detection signal 1 to the main control unit. In the Y direction, the device to be charged contacts the detection switch 2 to generate a detection signal 2, and transmits the detection signal 2 to the main control unit. In the Z direction, the device to be charged contacts the detection switch 3 to generate a detection signal 3, and transmits the detection signal 3 to the main control unit. When simultaneously detecting the detection signal 1, the detection signal 2 and the detection signal 3, the main control unit sends the communication execution instruction to the execution unit, and the execution unit executes the closing operation according to the communication execution instruction. Thus, the charging connection confirmation signal, the communication signal and the auxiliary power supply signal are transmitted from the fixed side of the flexible charging device to the side of the charging station, the communication circuit between the charging station and the device to be charged is connected, and whether the communication state is normal is determined according to the charging connection confirmation signal and the communication signal. When the communication is normal, the DC contactor in the charging station is closed, connecting the charging circuit between the device to be charged and the charging station as a charging switch, to start charging.

Specifically, the charging connection confirmation signal CC1, the communication signal CAN+ and the communication signal CAN− are transmitted to a DC charging station controller to judge whether the communication state is normal. When the communication state is normal, the DC charging station controller controls the closing of a DC contactor to realize the connection of the charging circuit between the device to be charged and the DC charging station on one hand. On the other hand, the DC charging station controls the closing of the auxiliary power relay to connect the auxiliary power circuit between the switching power supply and the device to be charged, so that the auxiliary power positive signal A+ and the auxiliary power negative signal A—generated by the switching power supply are transmitted to the device to be charged through the auxiliary power relay. In addition, the DC charging station also contains a molded case circuit breaker (MCCB), which is used to control the on/off between the DC charging station and the input AC power. Further, after the molded case circuit breaker is connected, it is divided into three paths, wherein the first path converts AC power into DC power used for the charging circuit through a DC module; the second circuit converts AC power into an auxiliary power signal through a switching power supply; and the third circuit generates the power supply for the detection unit, the main control unit and the execution unit through the AC to DC control power supply. That is, the U1 and N1 power lines in the DC charging station are led out to supply power to the detection unit by the first power supply unit (that is, the AC to DC control power supply), and lead out the output voltage of the first power supply unit to supply power to the main control unit and the execution unit by the second power supply unit (that is, the DC to DC control power supply).

Further, the execution unit is a relay containing five switches, and the execution unit executes the closing operation of the relay according to the communication execution instruction, so that the charging connection confirmation signal CC1, the communication signal CAN+ and the communication signal CAN− are transmitted from the fixed side of the flexible charging device to the side of the charging station, and the communication circuit between the charging station and the device to be charged is connected. The auxiliary power supply positive signal A+ and the auxiliary power supply negative signal A− are transmitted from the side of the charging station to the fixed side of the flexible charging device, and the auxiliary power circuit between the charging station and the device to be charged is connected.

It should be noted that the detection switch 1, the detection switch 2 and the detection switch 3 can be travel switches, proximity switches, or other distance sensing devices besides travel switches and proximity switches.

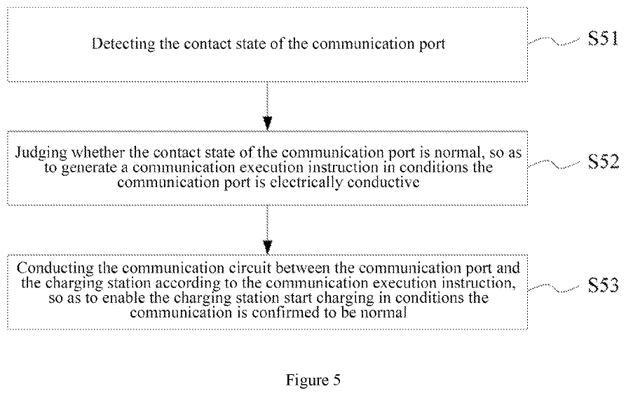

Please refer to FIG. 5, which shows the schematic flowchart of the charging control method in an embodiment of the disclosure. As shown in FIG. 5, the charging control method specifically comprises the following steps:

S51, detecting the contact state of the communication port.

In an embodiment, the S51 step is executed through a detection unit, wherein the detection unit comprises a first detection switch, a second detection switch and a third detection switch, the first detection switch is used to detect the contact state in a X direction, the second detection switch is used to detect the contact state in a Y direction, and the third detection switch is used to detect the contact state in a Z direction. The step of judging whether the contact state of the communication port is normal, so as to generate a communication execution instruction in conditions the communication port is electrically conductive comprises: when simultaneously obtaining the detection signals of the first detection switch, the second detection switch and the third detection switch, generating the communication execution instruction.

In another embodiment, the S51 step is executed through the detection unit, the detection unit comprises a travel switch and a proximity switch, the travel switch is used to detect the contact state in a X direction, and the proximity switch is used to detect the contact state in a Y direction. The step of the judging whether the contact state of the charging port and communication port are normal, so as to generate a communication execution instruction in conditions the charging port and communication port both are normal is electrically conductive comprises: when simultaneously obtaining the detection signals of the travel switch and the proximity switch, generating the communication execution instruction.

S52, judging whether the contact state of the communication port is normal, so as to generate a communication execution instruction in conditions the communication port is electrically conductive.

S53, conducting the communication circuit between the communication port and the charging station according to the communication execution instruction, so as to enable the charging station to start charging in conditions the communication is confirmed to be normal.

The protection scope of the charging control method described in the disclosure is not limited to the execution sequence of the steps listed in the present embodiment. All solutions implemented by adding, subtracting and replacing steps of the existing technology according to the principles of the disclosure are comprised in the protection scope of the disclosure.

The principle of the charging control device described in the disclosure corresponds to the charging control method one by one. The charging control device described in the disclosure can achieve the charging control method described in the disclosure, but the implementation device of the charging control method described in the disclosure comprises but is not limited to the structure of the charging control device listed in the present embodiment. Any structural deformation and replacement of the existing technology made according to the principles of the disclosure, are all comprised in the scope of protection of the disclosure.

To sum up, the charging control device and the charging control method of the disclosure detect the contact state of the communication port through the main control unit, and the control execution unit conducts the communication circuit between the communication port and the charging station when the contact state is conductive, thereby achieving the detection of communication status to start charging when the communication status is normal. Thus, double insurance of contact state and communication state detection is achieved in the communication circuit detection of the charging control process, which can maximize the reliability and safety of charging. Further, the communication port of the disclosure is connected to the device communication port of the device to be charged through a contact mechanical port. Comparing with the non-contact communication of the existing communication coil, the communication reliability is higher. The disclosure effectively overcomes various shortcomings in the existing technology and has high industrial utilization value.

The above embodiments only exemplary explained the principle and efficacy of the disclosure, and are not used to limit the disclosure. Anyone familiar with this technology may modify or change the above embodiments without violating the spirit and scope of the disclosure. Therefore, all equivalent modifications or changes made by those with ordinary knowledge in the technical field without departing from the spirit and technical ideas disclosed in the disclosure, shall still be covered by the claims of the disclosure.

1. A charging control device, wherein two sides of the charging control device are respectively connected to a device to be charged and a charging station, and the charging control device comprises:
a charging port, connected to the device to be charged by one end, and connected to a contactor of the charging station by another end, for achieving contact connection of a charging circuit between the device to be charged and the charging control device;
a communication port, connected to a device communication port of the device to be charged, for achieving contact connection of a communication circuit between the device to be charged and the charging control device;
a main control unit, for judging whether contact state of the communication port is normal, so as to generate a communication execution instruction in conditions the communication port is electrically connected;
an execution unit, respectively connected to the main control unit and the communication port, for receiving the communication execution instruction sent by the main control unit, and conducting the communication circuit between the communication port and the charging station according to the communication execution instruction, so as to enable the charging station start charging in conditions the communication is confirmed to be normal; and
a power supply unit, connected to the main control unit and the execution unit.

2. The charging control device according to claim 1, wherein
the communication port is a contact mechanical port, for transmitting signal between the charging control device and the device to be charged in a contact manner.

3. The charging control device according to claim 2, wherein
the communication port comprises a first charging connection confirmation port and a control confirmation port;
the execution unit is used to perform an on/off operation between the first charging connection confirmation port and the charging station, as well as an on/off operation between the control confirmation port and the charging station.

4. The charging control device according to claim 2, wherein
the communication port comprises a second charging connection confirmation port, a first communication port, a second communication port, an auxiliary power supply positive port, and an auxiliary power supply negative port;
the execution unit is used to perform an on/off operation between the second charging connection confirmation port, the first communication port, the second communication port, the auxiliary power supply positive port, the auxiliary power supply negative port and the charging station.

5. The charging control device according to claim 1, wherein the charging control device further comprises:
a detection unit, connected to the main control unit, for generating a detection signal when the device communication port contacts the communication port; the detection signal is used to indicate that electrical conductivity between the communication port and the device communication port is normal.

6. The charging control device according to claim 5, wherein
the detection unit comprises a travel switch and a proximity switch; the travel switch is used to detect contact state in a X direction, and the proximity switch is used to detect contact state in a Y direction;
the main control unit is connected to the travel switch and the proximity switch respectively, for receiving detection signals from the travel switch and the proximity switch.

7. The charging control device according to claim 5, wherein
the detection unit comprises a first detection switch, a second detection switch and a third detection switch; the first detection switch is used to detect contact state in a X direction, the second detection switch is used to detect contact state in a Y direction, and the third detection switch is used to detect contact state in a Z direction;
the main control unit is connected to the first detection switch, the second detection switch and the third detection switch respectively, for receiving detection signals from the first detection switch, the second detection switch and the third detection switch.

8. The charging control device according to claim 5, wherein
the power supply unit comprises a first power supply unit and a second power supply unit;
the first power supply unit is connected to the detection unit, and supplies power to the detection unit;
the second power supply unit is connected to the main control unit and the execution unit, and supplies power to the main control unit and the execution unit.

9. A charging control method, wherein the charging control method comprising:
detecting contact state of a communication port;
judging whether the contact state of the communication port is normal, so as to generate a communication execution instruction in conditions the communication port is electrically conductive;
conducting the communication circuit between the communication port and charging station according to the communication execution instruction, so as to enable the charging station start charging in conditions the communication is confirmed to be normal.

10. The charging control device according to claim 9, wherein the step of detecting contact state of a communication port is performed by a detection unit, the detection unit comprises a first detection switch, a second detection switch and a third detection switch; the first detection switch is used to detect the contact state in a X direction, the second detection switch is used to detect the contact state in a Y direction, and the third detection switch is used to detect the contact state in a Z direction; the step of the judging whether the contact state of the communication port is normal, so as to generate a communication execution instruction in conditions the communication port is electrically conductive comprises:
generating the communication execution instruction when simultaneously obtaining detection signals of the first detection switch, the second detection switch and the third detection switch.
